(19) United States
(12) Patent Application Publication
(10) Pub. No.: US 2005/0055197 A1
(43) Pub. Date: Mar. 10, 2005

(54) Linguographic method of compiling word dictionaries and lexicons for the memories of electronic speech-recognition devices

(76) Inventor: Sviatoslav Karavansky, Denton, MD (US)

Correspondence Address: Sviatoslav Karavansky, 300 Fountain Ave., P. O. B. 131, Denton, MD, 21629, US

(21) Appl. No.: 10/640,992

(22) Filed: Aug. 14, 2003

(51) Int. Cl. G06F 17/20

(52) U.S. Cl. 704/1

(57) ABSTRACT

The present invention is a new—linguographic—method of compiling the word dictionaries and lexicons, assigned for memories and other equipments of speech-recognition devices (SRD). The linguographic method is based on the simulation of the natural speech signals' accumulation and storage by the human language center (HLC). The linguographic method differs from the traditional lexicographic method of word dictionaries' composition by next features: A. It uses, as the primary element of word classification for the word dictionaries and lexicons, the stressed vowel of the speech signal; B. It uses a number of newly elaborated characteristics for the classification of speech signals in said dictionaries; C. It uses the Sound Alphabeth, invented by the inventor, for defining the sequence of signals' characteristics in the word dictionaries and lexicons. When using the lexicons, based on the linguographic method, in speech-recognition devices' memory and other speech recognizing equipments, there will be no need of many additional searches, because each word, listed in the device memory and other device equipments, will carry all or almost all the information, needed for the speech recognition.

### REFERENCES CITED: U.S. PATENT

U.S. Pat. No. 5,806,033 September 1998 Lyberg

### FEDERALLY SPONSORED RESEARCH OR DEVELOPMENT

(Not applicable)

### COMPACT DISC APPENDIX

(Not applicable)

### BACKGROUND OF THE INVENTION

The invention relates to composition of word dictionaries, used in the memories and other equipments of today's electronic speech-recognition devices. The effectiveness of these devices depends to a great degree on the inputted in the devices' memories dictionaries or lexicons. The lexicons, used in today's electronic devices, being compiled by the traditional lexicographic method are the main cause of the size and weak effectiveness of said devices. The improvement of the functions of today's speech-recognition devices requires to simulate the natural method of accumulation and storage of speech signals by the human language center (HLC). The HLC, despite its small size, is able to receive, accumulate, store, analyse and operate using millions of words, belonging to several languages. No modern computer can achieve such a compactness. This invention presents a new method for compiling aforementioned word dictionaries and lexicons.

### BRIEF SUMMARY OF THE INVENTION

The present invention provides a new—linguographic—method for the compiling of word dictionaries and lexicons, used in today's speech-recognition devices. The new linguographic method simulates the natural system of accumulation and storage of sound speech signals in the HLC.

### BRIEF DESCRIPTION OF THE DRAWINGS

FIG. 1. The Diagram of the Lexicographic Method of Wordbookung.

FIG. 2. The Diagram of the Linguographic Method of Wordbooking.

FIG. 3. Stuctural Types of English-American Vocabulary.

FIG. 4. The Accumulation Channel of the Stressed Syllable [IZ]

FIG. 5. The Block Diagram of the U.S. Pat. No. 5,806,033

### DETAILED DESCRIPTION OF THE INVENTION

The linguographic method for the compiling lexicons, assigned to the speech-recognition devices, is a copy of the natural method, used by the Human Language Center (HLC) for the formal accumulation (and storage) of speech signals¹. The de-scription of the invention requires to exercise some research of language simulation by means of linguistics. The next numbered subsections are dedicated to this research.
¹Considering the issue theoretically, we disregard the difference between the orthography and orthoepy that exists in the majority of languages and suppose that one letter in writing corresponds to one sound in pronunciation and vice versa. This supposition is true when we deal with phonetically transcribed signals. So, compiling the described further linguographic model, we defined the sound structure of English words, proceeding from the phonetic transcription,

SUBSECTION 1. The Simulation of the Language Phenomena by Means of Linguistics.

Each lexicographic work (a dictionary) may be considered as a model of the system of the formal receiving, accumulating and storing speech signals by the HLC. This applies especially to the unilingual dictionaries, such as spelling, defining and so on dictionaries, that register the words of one language according to a certain order. Each such a dictionary simulates to a certain degree the system of the formal accumulation of the speech signals by the HLC. Saying so, we do not touch the question, how close to the reality it is done. In order to answer this question, let us examine the principles of compiling the dictionaries, which in the light of our research, we will call the lexicographic models.

The lexicographers accept the first sound of the word as a primary characteristic for the classification of signals in the dictionary. All the words in the dictionary are broken up into several rubrics of words, beginning with a certain sound (letter). For the row of languages, the sequence of rubrics is defined by traditional Latin alphabet:
A, B, C, D, E, F, G, E, I, J, K, L, M, N, O, P, Q, R, S, T, U, V, W, X, Y, Z

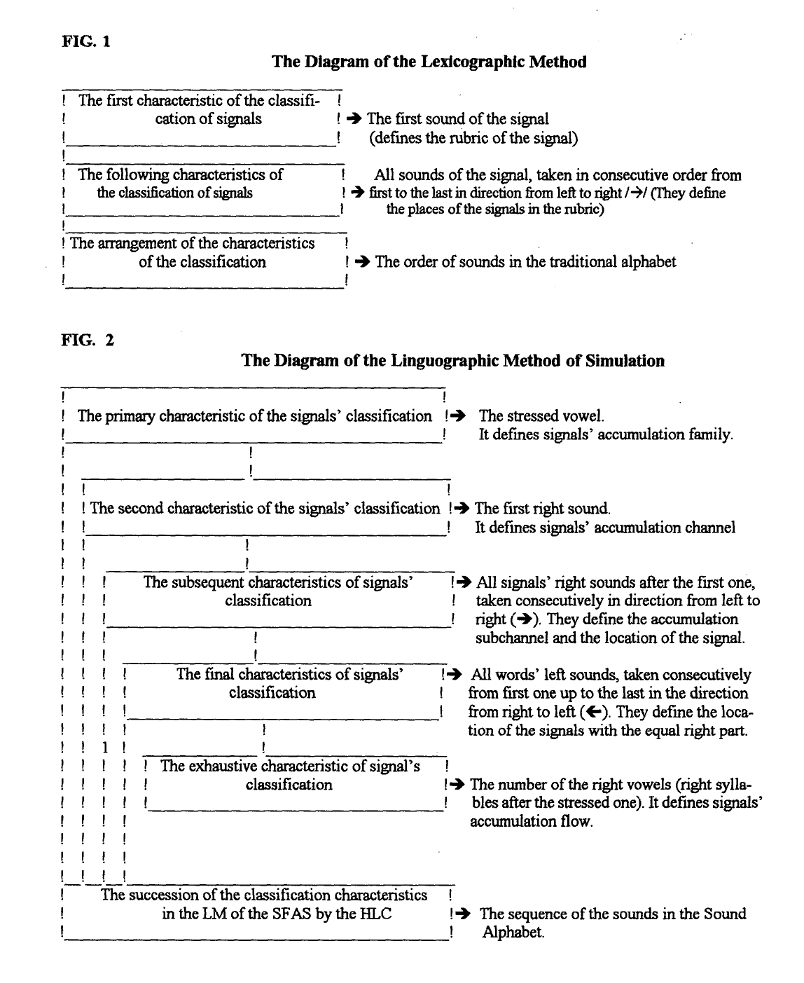

The number of rubrics in the traditional dictionary is equal to the number of letter in the alphabet. Within the limits of each rubric, the words are grouped, depending on the second sounds of signals. So, in the rubric A, the words that start with AA are written first (AA group), then—the words that start with AB (AB group), then—AC group, then—AD group, then—AE group and so on. In other words, the second sound of the signal serves as a second characteristic of classification. The sequence, in which words are placed within the limits of each group, is defined by order of traditional alphabet, applied to the third sound of the signal. In the AB group, the words, starting with ABA (ABA subgroup), are written first, then—the words, starting with ABB (ABB subgroup), then—the words, starting with ABC (ABC subgroup), then the subgroups ABD, ABE, ABF etc. So, the third characteristic of the classification of signals is theirs third sound. The further arrangement of words in the lexicographic model is defined by the fourth, then—by the fifth sounds of the signal and so on up to the last one. It may be represented diagrammatically (FIG. 1).

SUBSECTION 2. The Conception of the Linguographic Method

Assuming that each traditionally compiled dictionary is a lexicographic model that simulates the system of the formal accumulation of the signals (SFAS) in the HLC, we should note the shortcomings of the lexicographic method.

Shortcoming 1. The first sound of the signal can not fulfill the function of the primary accumulation element of signals in the HLC, because the first sound of the signal sometimes changes, but the meaning of the word does not, so the accumulation channel of the signal does not change, hence this channel does not depend on the word's first sound. The rightness of this statement is easy to trace on the following examples. The English words

| | | | |
|---|---|---|---|
| (1) | live - (adverb) | (2) | ‘tween - (preposition) |
| (1) | alive - (adverb) | (2) | between - (preposition) |

are attributed by the lexicographers to the different rubrics: live—to the rubric L, and the word alive—to the rubric A; the word 'tween—to the rubric T, and the word between—to the rubric B. But there is no need to prove that HLC accumulates such versions of words in very near (or even the same) channels. The same may be said about English words

‘neath
beneath
underneath

The HLC accumulates these words in very near (or the same) channel, but the lexicographic model does not reflect this fact, placing these words in different rubrics.

Thus, the first sound of the signal does not fulfill the function of the primary element of speech signals' accumulation in the HLC² and cannot serve as the first characteristic of the classification of signals for the genuine simulation of the SFAS in the HLC.
² The first sound of the signal serves as primary element of the reception of sounds of the signal in the HLC. The HLC receives all sounds of the signal in consecutive order (first, second, third and so on up to the last) in direction from left to right ( [symbol] ), when speaking about the written words. But the order of the reception of signals' sounds in the HLC does not coincide with the order of the formal accumulation of them, and this will be proven later on.

The same conclusion is derived after analysing the homographs. For instance:

| | | | | |
|---|---|---|---|---|
| cho'ral | a | and | chora'l | n |

The first sounds of these words coincide. All other sounds, judging from the spelling, coincide also, but these words differ in theirs stressed vowels (in theirs stressed syllables). The lack of coincidence in stressed vowels differenciate the structure of the homographs cardinally that becomes apparent in rhyming.

| | |
|---|---|
| So, the word chora'l is rhyming to the following row of words | morale |
| | corral |
| | kraal |
| | banal |
| | canal |
| | locale, |
| while the word cho'ral rhymes to another row of words | laurel |
| | moral |
| | immoral |
| | amoral |
| | quarrel |
| | coral |
| | sorrel. |

Hence, the words chora'l and cho'ral despite the identity in theirs first sounds and the identity in some other sounds, are two absolute different signals, which are accumulated in the HLC in different channels.

The lexicographic models (traditional dictionaries), placing homographs in one rubric (and side-by-side), does not simulate the accumulation channels of these signals in the HLC.

It is clear from all the above that the first sound of the signal does not play the definitive primary role in the process of accumulation of the signals in the HLC.

Shortcoming 2. The following elements (characteristics) of accumulation of signals in the lexicographic model, taken after the mistakenly chosen first element, can not satisfy the researcher either.

Shortcoming 3. In order that a model would truly reflect the SFAS in HLC, it is necessary that the sequence of the classification characteristics of speech signals in the model corresponds to the sequence of sound-receiving channels in the HLC. In the lexicographic model, the sequence of accumulation is controlled by the traditional alphabet. But the traditional alphabet, being created historically, does not simulate the sequence of sound-receiving channels in the HLC. The traditional alphabet does not distinguish the vowels from the consonants, despite the fact that they play different roles in the process of words' accumulation in the HLC.

The discussed shortcomings of the lexicographic models prove that following steps are necessary for the compiling of the genuine model of the SFAS in the HLC:
A. To choose correctly the primary and following characteristics of signals' accumulation by the HLC.
B. To approve in the genuine model of the SFAS by the HLC such an alphabet that would simulate the order of disposition of the sound-receiving channels in the HLC.

Let us call such a model that would genuinely reflect the picture of the formal accumulation and storage of signals by the HLC the Linguographic Model (LM) of the SFAS by the HLC. Next sections will explain the principles of the compilation of such a model.

SUBSECTION 3. The Alphabet of the Linguographic Model

The sequence of the sound-receiving channels in the HLC may be established by the cooperation of several scientific disciplines, including linguistics. For simulating purposes, such a sequence should serve as an alphabet in the LM. A row of considerations and the long-term observations of the language phenomena helped the inventor to elaborate the Sound Alphabet and apply it for the modelling the SFAS in the HLC.

In contrast to the traditional alphabet, the Sound Alphabet is compiled of two rows of sounds: the vowel row and the consonant row. These rows of the Sound Alphabet look for English sounds, transcribed by the International Phonetic Alphabeth (IPA), as follows:

The Row of Vowels

[ [symbol] ], [i:], [l [symbol] ], [l], [æ], [e [symbol] ], [el], [e], [α], [aυ], [al], [Λ], [ [symbol] ], [z,902 :], [ [symbol] :], [ [symbol] υ], [O/ [symbol] l], [u:], [υ]

In the vowel row, there are 19 vowels: 18 of them are found under the accents and one [ [symbol] ] is unstressed vowel.

The Row of Consonants

[R], [L], [J], [N], [η], [M], [V], [W], [F], [B], [P], [D], [T], [G], [K], [H], [Z], [S], [ [symbol] ], [θ], [3], [∫], [d3], [t∫]

The row of consonants, that follows the row of vowels, consists of 24 sounds.

In the LM, the sequence of the characteristics of the signals' classification is defined by the Sound Alphabet.

SUBSECTION 4. The Primary Characteristic of the Signals' Classification in the LM

The primary or the first characteristic of signals' classification in the LM was selected on the basis of the following considerations:

Consideration I.

The research of signals' changes in the process of the creation of lexical versions (historical, dialectical, colloquial and low colloquial), conducted by the inventor, showed that the most stable part of the speech signal is the stressed syllable.

The stability of the words' stressed syllable may be most likely explained by the fact, that the stressed syllable plays the paramount role in the accumulation and storing of signals by the HLC and therefore undergoes the modifications in the last turn.

The observations over the modifications of words' stressed syllable in the process of signals' variations had showed that the most stable sound in the stressed syllable is the stressed vowel, or to be more precise—the accentuation of the vowel. Sometimes, the vowel in the stressed syllable may be changed, but its accentuation does not change: Mutter [M-υ-TER]/German/, M-o-der/Danish/, mother [M-Λ-θ [symbol] R]/English/).

It is obvious, that the most stable element of the signal is the element, which undergoes changes in the last turn. Such an element is the primary element of the accumulation of signals in the HLC.

Consideration II.

How may the science explain the rhyming effect of signals from the physiological point of view? The trustworthiest explanation from this point of view is that the rhyming effect is the coincidence of the accumulation channels of signals in the HLC. Having this explanation in mind, let us scrutinize some columns of rhyming signals:

| [i:] | [æ] | [\hat{ }] | [u:] |
|---|---|---|---|
| ream | ram | rum | room |
| dream | dram | drum | broom |
| gleam | lam | plumb | loom |
| deem | dam | dumb | doom |
| teem | cam | come | coomb |
| scheme | jam | scum | zoom |

The signals in those columns rhyme, because their stressed vowels and following consonants are identical. The rhyming effect is full. The signals rhyme absolutely. But let us look at another example:

| [i:] | [æ] | [\hat{ }] | [u:] |
|---|---|---|---|
| ream | ram | rum | r om |
| kneel | plan | lull | fo l |
| keen | have | nun | m n |
| keep | pad | tub | coop |
| seed | tag | cud | chute |
| these | sash | buzz | g se |
| teach | badge | such | douche |

In these columns, the signals rhyme approximately or roughly. Such rhymes are called vowel rhymes. What we have here? We have identity in stressed vowels, while the consonants, following the vowels, differ in sound. Thus, the lack of identity in stressed consonants does not exclude the rhyming effect. This effect is weaker, but it still exists. Only the lack of identity in the stressed vowels excludes this effect completely. It is obvious from the next row of columns

| | | | | |
|---|---|---|---|---|
| ream | dream | gleam | deem | scheme |
| ram | dram | lam | dam | cam |
| rum | drum | plumb | dumb | come |
| room | broom | loom | doom | comb |

In the listed columns, the signals do not rhyme, despite the identity in the consonants of stressed syllables, because there is no identity in the stressed vowels. So, the rhyming effect requires the identity in the stressed vowels, not in the stressed consonants. The lack of identity in consonants does not exclude the rhyming effect completely, while the lack of identity in vowels excludes it. Assuming that the rhyming effect is the coincidence of the signals' accumulation channels, it is logical to conclude that the coincidence of the signals' accumulation channels is possible only with the identity in the signals' stressed vowels. So, the stressed vowel plays in the HLC the most decisive role.

Conclusion

The word's stressed vowel serves for the HLC as the primary element of signals' accumulation. In order to simulate the SFAS in the HLC correctly, it is necessary to accept this primary element of accumulation as the first characteristic of the signals' classification in the LM.

So, the first characteristic of signals' classification divides the English vocabulary into 18 families of accumulations, according to the number of stressed vowels in the Sound Alphabet. Taking into account the cognation of sounds, the 18 accumulation families may be grouped into 5 clans:

| | | | | | | | | |
|---|---|---|---|---|---|---|---|---|
| The | accumulation | families | of | the | sound | [ [symbol] ] | | |
| = | = | = | = | = | = | [ [symbol] ] | {close oversize brace} | the clan of the abstract sound [I] |
| = | = | = | = | = | = | [ [symbol] ] | | |
| = | = | = | = | = | = | [æ ] | | |
| = | = | = | = | = | = | [ [symbol] ] | | |
| = | = | = | = | = | = | [ [symbol] ] | {close oversize brace} | the clan of the abstract sound [E] |
| = | = | = | = | = | = | [e] | | |
| = | = | = | = | = | = | [ [symbol] ] | | |
| = | = | = | = | = | = | [ [symbol] ] | | |
| = | = | = | = | = | = | [ [symbol] ] | {close oversize brace} | the clan of the abstract sound [A] |
| = | = | = | = | = | = | [ [symbol] ] | | |
| = | = | = | = | = | = | [ [symbol] ] | | |
| = | = | = | = | = | = | [ [symbol] ] | | |
| = | = | = | = | = | = | [ [symbol] ] | | |
| = | = | = | = | = | = | [ [symbol] ] | {close oversize brace} | the clan of the abstract sound [O] |
| = | = | = | = | = | = | [ [symbol] ] | | |
| = | = | = | = | = | = | [u:] | | |
| | | | | | | | {close oversize brace} | the clan of the abstract sound [U] |
| = | = | = | = | = | = | [ [symbol] ] | | |

SUBSECTION 5. The Second Characteristic of the Signals' Classification in the LM.

Let us agree on the following terms:
1. Let us call the sounds of the written signal to the right from the stressed vowel the right sounds.
2. Let us call the sounds of the written signal to the left from the stressed vowel the left sounds.

Here is the visual explanation of these terms on the word discovery: 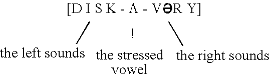
3. We will number the right sounds from left to right ( [symbol] )
4. The left sounds—from right to left ( [symbol] )

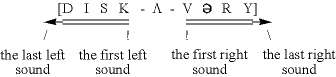

The selection of the second characteristic of signals' classification in the LM is based on the following considerations:

Consideration I.

The observations on the elements of the stressed syllable showed that the first right sound out of two consonants, surrounding the stressed vowel, is the most stable in the process of the versions modifications of signals. Following the conclusion that the most stable element of signal is accumulated in the HLC before the less stable, it is obvious that, after the stressed vowel, the HLC accumulates the first right sound.

Consideration II.

The stressed vowel creates a stable sonic unity with the first right sound, what is the indispensable condition of the absolute rhyming of signals.

| | | | |
|---|---|---|---|
| For instance, the signals | pap | [P - æ - P] | and |
| | rap | [R - æ - P] | |

are rhyming absolutely, because beside the identity in stressed vowels [æ] there is the identity in the first right consonants [P]. The lack of identity in the left sounds [P] and [R] does not transgress the effect of the absolute rhyming. But once the right sound in one of the signals is changed, the effect of the absolute rhyming is broken. For instance, the signals

| | | |
|---|---|---|
| pal | [P - æ - L] | and |
| pap | [P - æ - P] | |

do not rhyme absolutely, despite the fact that the stressed vowels [æ] and the left sounds [P] are identical, because the right sounds [L] and [P] are not identical. Such a pair is called vowel rhyme or assonance.

It is obvious, that the lack of identity in right sounds breaks the effect of the absolute rhyming.

In other words, in the presence in the stressed syllable both right and left sounds, the main role for the creation of rhyming effect, plays the right sound, hence it is the next ele-ment of signals' accumulation by the HLC after the stressed vowel.

Conclusion

The second element of the formal accumulation of signals by the HLC is the first right sound of the signal; and hence the second characteristic of the classification of signals in the LM of the SFAS by the HLC is the first right sound.

The second characteristic of the classification of signals breaks each family of accumulation into a row of channels. Theoretically, 18 families of accumulation with the 24 vowels (and the 25^{th} zero of sound) may create 450 accumulation channels, but practically the LM has less, because some vowels do not create accumulation channels with some consonants. For instance, the sound [i:] cre-ates 23 accumulation channels: 22 channels with the consonants, except [J] and [η], and one channel with the zero of sound—the channel of the pure sound [i:].

The order of the second characteristic of the signals' classification in the LM is defined by the consonant row of the Sound Alphabet. A list of the accumulation channels of the sound [i:], in order in which they appear in the LM, is cited below:
[i:], [i:R], [i:L], [i:N], [i:M], [i:V], [i:W], [i:F], [i:B], [i:P], [i:D], [i:T], [i:G],[i:K], [i:H], [i:Z], [i:S], [i: [symbol] ], [i:θ], [i:3], [i:∫], [i:d3], [i:t∫].

SUBSECTION 6. The Subsequent Characteristics of the Classification of Signals in the LM

The observations of the signals that have more than one right sound—teacher, mantle—show that not only the first right sound takes part in the rhyming effect, but all the subsequent right sounds also. For instance, the words

| | | |
|---|---|---|
| delve | [D - e - LV] | and |
| twelve | [TW - e - LV] | |

rhyme absolutely, i.e. the first and the second right sounds [L] and [V] are identical in this pair of words. But in case, when second right sounds of the rhyming pair are not identical, the rhyming effect is not absolute, and the signals rhyme only roughly as vowel rhymes or assonants. This is seen on the next pair of signals:

| | | | |
|---|---|---|---|
| | delve | [D - e - LV] | and |
| | dealt | [D - e - LT]. | |
| Equally, the words | hand-glass | [H - æ - NDGLα:S] | and |
| | sand-glass | [S - æ - NDGLα:S] | |

rhyme absolutely, because their right sounds are identical, but the words

| | | |
|---|---|---|
| hand-glass | [H - æ - NDGLα:S] | and |
| hand-grip | [H - æ - NDGRIP] | |

are not a classical rhyming pair, for their right sounds are not fully identical, even if their left sounds—[H]—are the same.

The participation of all right sounds in the rhyming effect is indicative of the fact that, after the first right sound, all right sounds take part successively in the accumulation of the signal by the HLC.

Conclusion

The subsequent characteristics of signals' classification in the LM are all right sounds of the signal after the first to the last, taken successively (in the direction from left to right [symbol] when speaking about written words).

The subsequent characteristics of the signals' classification in LM fulfill the following functions:
a) They single out a row of subchannels in a certain accumulation channel;
b) They define the location of a signal in the subchannel.

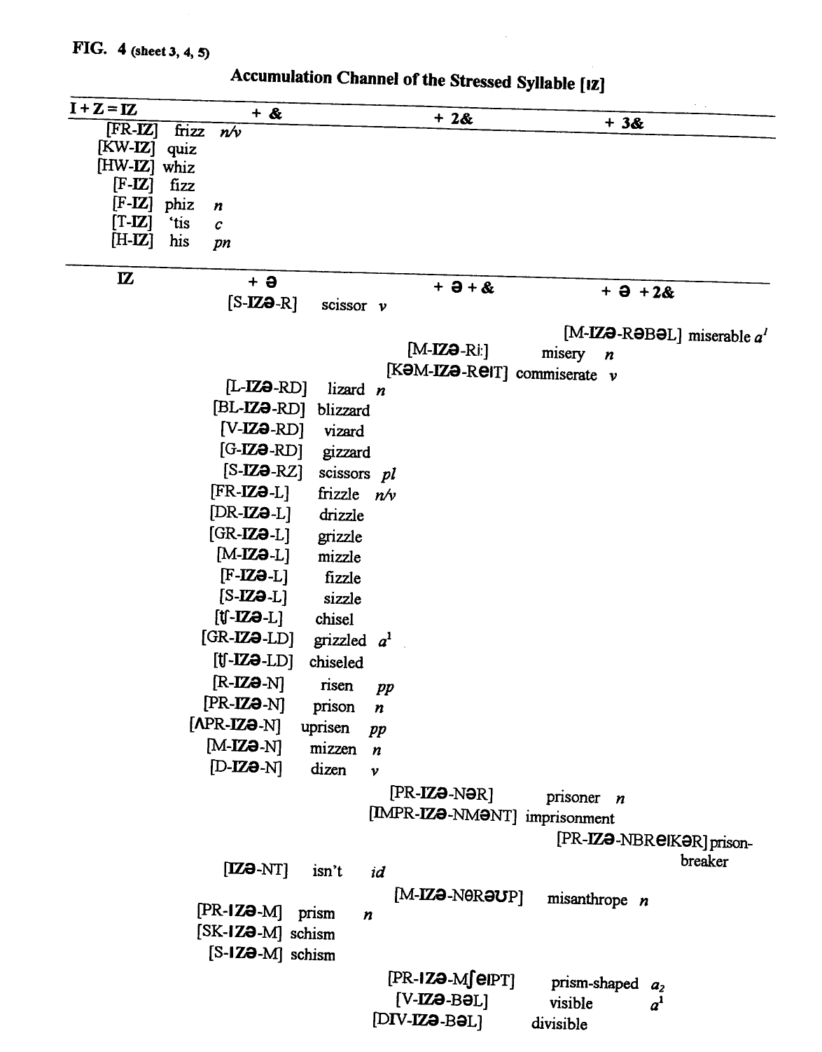

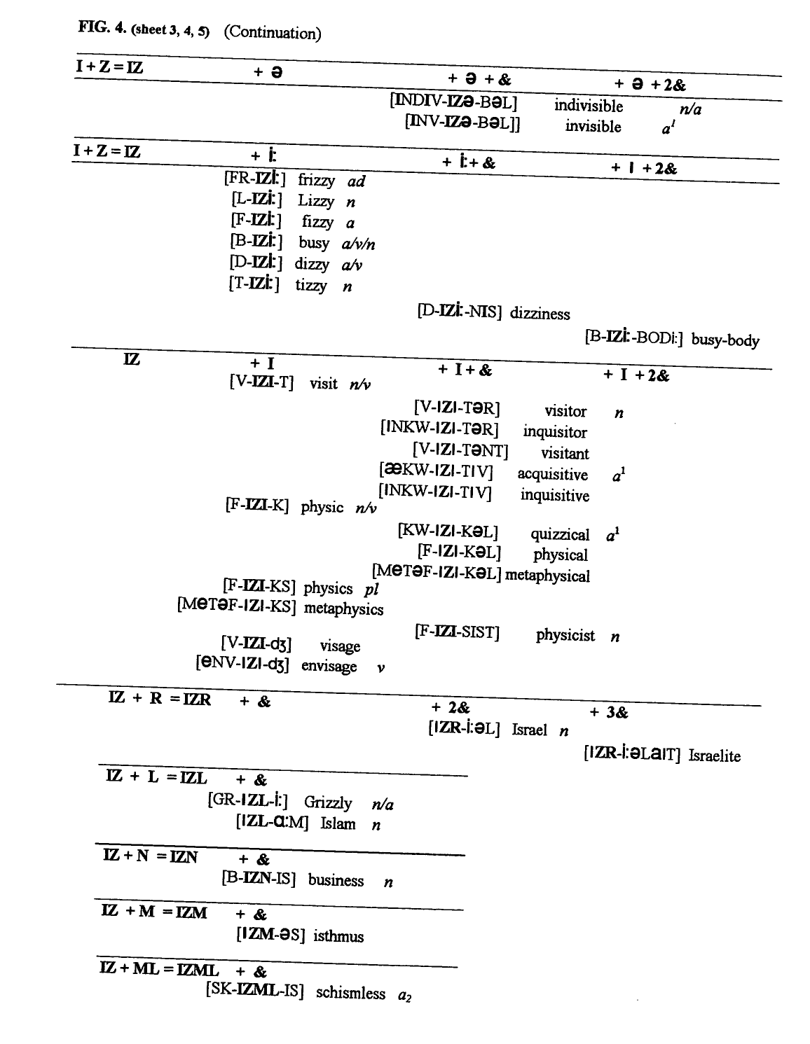

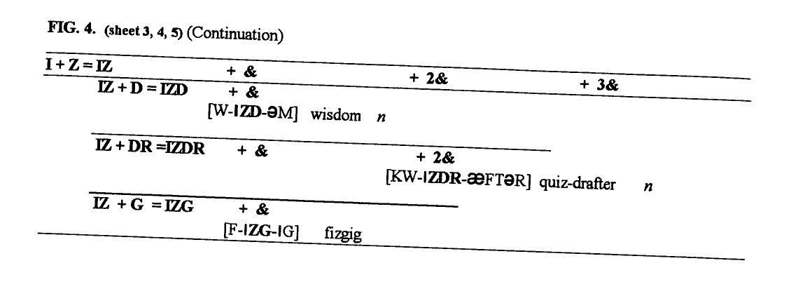

These functions of the subsequent characteristics of the signals' classification in the LM are visually displayed when we register a certain amount of signals with a certain stressed syllable, for instance, the syllable [lZ]. The Accumulation Channel of the Stressed Syllable [lZ] (FIG. 4) dis-plays the division of the accumulation channel [lZ] into a row of subchannels. The channel [lZ] is divided into a row of following subchannels as a result of the addition of sounds [ [symbol] ], [i:], [I], [R], [L], [M], [ML], [D], [DR], [G] to the syllable [lZ]:

[IZ [symbol] ]
[IZi:]
[IZI]
[IZR]
[IZL]
[IZN]
[IZM]
[IZML]
[IZD]
[IZDR]
[IZG]

For singling out the accumulation subchannel from a channel, it is quite enough to add the second right sound to the first one, if the second sound is a vowel, or if it is a consonant, followed by a vowel or a zero of sound. According to this guide, there are singled out the following subchannel in channel [IZ]:
[lZ [symbol] ], [lZi:], [lZl], [lZR], [lZL], [lZN], [lZM], [lZD], [lZG].

But if the second right sound is a consonant, followed by some other consonants, then for the singling out an accumulation subchannel, all the right sounds after the second one up to the appearance of a vowel or a zero sound should be taken. According to this rule, the following subchannels are singled out from the channel [lZ]:
[lZML], [lZDR].

All right sounds of the signal that do not take part in the singling out the subchannel define the location of the signal in the subchannel. To make this statement understandable, let us copy a part of the subchannel [ml from The Accumulation Channel of the Syllable [lZ] (FIG. 4):

| | |
|---|---|
| lizard | [L - IZ [symbol] - RD] |
| blizzard | [BL - IZ [symbol] - RD] |
| wizard | [W - IZ [symbol] - RD] |
| gizzard | [G - IZ [symbol] - RD] |
| scissors | [S - IZ [symbol] - RZ] |
| frizzle | [FR - IZ [symbol] - L] |
| drizzle | [DR - IZ [symbol] - L] |
| grizzle | [GR - IZ [symbol] - L] |
| mizzle | [M - IZ [symbol] - L] |

Why these words are written in such an order?

Since we accepted the Sound Alphabet as the order of the accumulation channels in the HLC, we apply this alphabet to define the order of signals' right sounds in the LM. So, the signals that have the sound [RI after the first right vowel [ [symbol] ] should be placed before the signals that have the sound [L] after the first right vowel. The sounds [R] and [L] are the sounds that do not take part in the singling out the subchannel. The subchannel is singled out by the sound [ [symbol] ].

So the right sounds [RD], [RZ] and [L], which do not take part in the singling out the subchan-nel [IZ [symbol] ], define the location of signals in their subchannel. The signals with the right sounds [RD] are placed before the signal with the right sounds [RZ] and all of them—[RD] and [RZ]—are placed before the signals with the right sounds [L], according to the Sound Alphabet, because accepting this alphabet in the LM, we apply it to the arrangement of the characteristics of the signals' classification in the LM.

SUBSECTION 7. The Final Characteristics of Signals' Classification in the LM

The accumulation of the right sounds of signal is not the end of the signal accumulation process in the HLC. The left sounds of the signal are still not accumulated. What is the further step of accumulation?

The next considerations will help to answer this question.

Consideration I. The observations over the stability of the signals' elements in the process of the natural versions' modifications showed that the first left sound of the signal is the most stable sound in all left part of the signal. So, the primary accumulation element of the left sounds is the first left sound.

Consideration II. Let us have a look at the list of signals with equal right part.

| | | | |
|---|---|---|---|
| you | [J - u:] | | |
| drew | [DR - u:] | | |
| Manchu | [ [symbol] - u:] | | |
| dew | [DJ - u:] | | |
| crew | [KR - u:] | | |
| do | [D - u:] | | |
| slew | [SL - u:] | | |
| chew | [ [symbol] - u:] | | |
| rue | [R - u:] | | |
| Urdu | [ [symbol] - u:] | {close oversize brace} | Row of signals # 1 (Right part = |
| screw | [SKR - u:] | | zero) |
| new | [NJ - u:] | | |
| clue | [KL - u:] | | |
| lieu | [LJ - u:] | | |
| blue | [BL - u:] | | |
| through | [θR - u:] | | |
| Hindu | [HIND - u:] | | |
| pew | [PJ - u:] | | |
| bedew | [BIDJ - u:] | | |

There is in this list of signals a necessary condition for the absolute rhyming: they have identity in the stressed vowel [U:] and the right part of the signals coincides (in the present case, it is equal to zero). At the same time, the rhyming effect is apparently stronger for some signals and—fainter for some others. The signals that have the identity in the first left sound (FLS) have a stronger or more precise rhyming effect.

Let us single out from this list the groups of signals that have FLS.=[R], [L],

| | | | | | | |
|---|---|---|---|---|---|---|
| drew | [D - Ru:] | | | | | |
| crew | [K - Ru:] | | | | | |
| rue | [ - Ru:] | {close oversize brace} | FLS = [R] | | | |
| screw | [SK - Ru:] | | | | | |
| through | [θ - Ru:] | | | | | |
| | | | slew | [S - Lu:] | | |
| | | | clue | [K - Lu:] | {close oversize brace} | FLS = [L] |
| | | | blue | [B - Lu:] | | |
| you | [ - Ju:] | | | | | |
| dew | [D - Ju:] | | | | | |
| new | [N - Ju:] | | | | | |
| lieu | [L - Ju:] | {close oversize brace} | FLS = [J] | | | |
| pew | [P - Ju:] | | | | | |
| bedew | [BID - Ju:] | | | | | |
| | | | do | [ - Du:] | | |
| | | | Urdu | [ [symbol] - Du:] | {close oversize brace} | FLS = [D] |
| | | | Hindu | [HIN - Du:] | | |
| Manchu | [M [symbol] N - [symbol] u:] | | | | | |
| | | {close oversize brace} | FLS = [ [symbol] ] | | | |
| chew | [ - [symbol] u:] | | | | | |

It is obvious, that the signals that have identical first left sound (rue-crew; clue-blue; you-new [JU:-NJU:]; do-Urdu; chew-Manchu) achieve the best rhyming effect among the signals with the identical right part.

On the other hand, the identity of the last left sounds does not amplify the rhyming effect. For instance:

| | | | | | | | | |
|---|---|---|---|---|---|---|---|---|
| (1) | skew | [SKJ - u:] | (2) | dew | [DJ - u:] | (3) | cue | [KJ - u:] |
| (1) | slew | [SL - u:] | (2) | drew | [DR - u:] | (3) | clue | [KL - u:] |

The signals in the forewritten pairs do not rhyme more precisely from the fact that theirs last left sounds are identical: [S] in the first pair, [D] in the second pair and [K] in the third.

To give a complete picture, let us look on the column of signals with the right part more than zero:

| | | | |
|---|---|---|---|
| reality | [Ri: - æ - LITi:] | | |
| normality | [ [symbol] - æ - LITi:] | | |
| frugality | [FRU:G - æ - LITi:] | | |
| neutrality | [NJu:TR - æ - LITi:] | | |
| cordiality | [ [symbol] - æ - LITi:] | | |
| formality | [ [symbol] - æ - LITi:] | {close oversize brace} | Row of signals # 2 (the right part is wide enough) |
| prodigality | [ [symbol] - æ - LITi:] | | |
| morality | [M [symbol] R - æ - LITi:] | | |
| legality | [Li:G - æ - LITi:] | | |
| plurality | [ [symbol] - æ - LITi:] | | |
| conjugality | [ [symbol] - æ - LITi:] | | |

The rhyming effect for some signals of this column amplifies, when one or several left sounds are identical (with the identity in the right part). It is easy to be convinced of this by singling out the signals with the identical FLS:

| | | | | | |
|---|---|---|---|---|---|
| normality | [ [symbol] - æ - LITi:] | | FLS = [M] | | |
| | | {close oversize brace} | | {close oversize brace} | FLS = [M] (the second and third left |
| formality | [ [symbol] - æ - LITi:] | | FLS = [M] | | sounds in this pair are identical also) |
| frugality | [FRu:G - æ - LITi:] | | FLS = [G] | | |
| prodigality | [ [symbol] - æ - LITi:] | | FLS = [G] | | |
| legality | [Li:G - æ - LITi:] | {close oversize brace} | FLS = [G] | {close oversize brace} | FLS = [G] |
| conjugality | [ [symbol] - æ - LITi:] | | FLS = [G] | | |
| neutrality | [NJu:TR - æ - LITi:] | | FLS = [R] | | |
| morality | [M [symbol] R - æ - LITi:] | {close oversize brace} | FLS = [R] | {close oversize brace} | FLS = [R] |
| plurality | [ [symbol] - æ - LITi:] | | FLS = [R] | | |

It is clear from these examples that the signals with the sufficiently wide right part rhyme more precisely, when their FLS is identical/with the equal right part/.

Alike the signals in the row #1, the signals in the row #2 demonstrate no improvement of the rhyming effect, when their last left sounds are identic. For instance:

| | | |
|---|---|---|
| cordiality | [ [symbol] - æ - LITi:] | } the last left sound is [K] |
| conjugality | [ [symbol] - æ - LITi:] | } the last left sound is [K] |
| normality | [ [symbol] - æ - LITi:] | } the last left sound is [N] |
| neutrality | [NJU:TR - æ - LITi:] | } the last left sound is [N] |

The signals in the forewritten pairs do not rhyme more precisely in spite of the fact that the last left sounds are identical. These examples show that the accumulation of the left sounds in the HLC begins from the first left sound.

Conclusion

After the accumulation of the right sounds of the signal, the HLC accumulates the first left sound (FLS); hence the first left sound (FLC) should be selected as the further characteristic after the exhaustion of the subsequent characteristics of classification in the LM.

Consideration III

Let us look on the row of signals with the identical right part, whose first left sounds are identical also:

| | | | |
|---|---|---|---|
| vestee | [VeST - i:] | | |
| grantee | [ [symbol] - i:] | | |
| rejectee | [ [symbol] - i:] | | |
| trustee | [ [symbol] - i:] | {close oversize brace} | FLS = [T] |
| dementi | [ [symbol] - i:] | | |
| departee | [ [symbol] - i:] | | |
| repartee | [ [symbol] - i:] | | |

It is obvious that signals, which have identical second left sound, rhyme more precisely. Let us single out from this row the signals whose second left sound is identical:

| | | | |
|---|---|---|---|
| vestee | [VeST - i:] | | |
| | | {close oversize brace} | FLS = [T]; the second left sound = [S] (1) |
| trustee | [ [symbol] - [symbol] ] | | |
| departee | [ [symbol] - i:] | | |
| | | {close oversize brace} | FLS = [T]; the second left sound = [R] (2) |
| repartee | [ [symbol] - i:] | | |

The signals (1) and (2) are rhyming more precisely than signals (3) and (4):

| | | |
|---|---|---|
| grantee | [ [symbol] - i:] | FLS = [T]; the second left sound = [N] (3) |
| rejectee | [ [symbol] - i:] | FLS = [T]; the second left sound = [K] |
| trustee | [ [symbol] - i:] | FLS = [T]; the second left sound = [S] (4) |
| dementi | [ [symbol] - i:] | FLS = [T]; the second left sound = [ [symbol] ] |

Conclusion

After accumulating the first left sound, the HLC accumulates the second left sound then third left sound and so on up to the last left sound.

The Summary Conclusion

After the accumulation of the right sounds, the HLC accumulates consecutively all left sounds, starting from the first one up to the last (in the direction from right to left [symbol] , when speaking about the written words).

Let us demonstrate this rule visually on the word discovery: 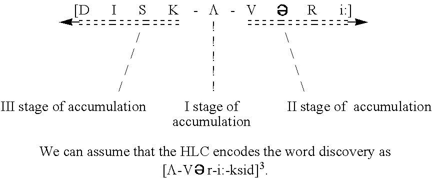
³ As we see, the order of the accumulation of the signals' sounds in the HLC does not coincide with the order of their reception. The order of the reception of the sounds of the word discovery should be written as follows:

Conclusion for the LM

After the exhaustion of the subsequent characteristics of the signals' classification in the LM of the SFAS in the HLC, all left sounds of the signal, taken consecutively from the first up to the last one (in direction from right to left [symbol] for the written words), are accepted as the further characteristics of classification.

We will call these characteristics of classification the FINAL characteristics.

The sequence of the final characteristics of signals' classification in the HLC defines the Sound Alphabet.

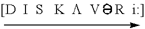

The lack of coincidence in the order of signals' reception and accumulation may be demonstrated visually on the homographs. The succession of sounds' reception for the homographs coincides:

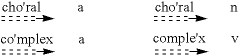

But the order of sounds' accumulation of these signals by the HLC is different:

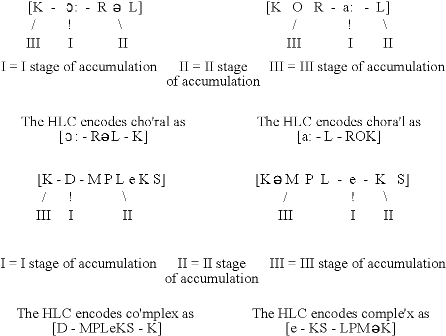

The final characteristics of classification in the LM define the location of signals in the accumulation channels and subchannels.

Let us look on the arrangement of a column of signals in the subchannel [lZ [symbol] ] of The Accumulation Channel of the Stressed Syllable [IZ] (FIG. 4).

| | |
|---|---|
| frizzle | [FR - IZ [symbol] - L] |
| drizzle | [DR - IZ [symbol] - L] |
| grizzle | [GR - IZ [symbol] - L] |
| mizzle | [M - IZ [symbol] - L] |
| fizzle | [F - IZ [symbol] - L] |
| sizzle | [S - IZ [symbol] - L] |
| chisel | [t∫ - IZ [symbol] - L] |

In this column, the final characteristics of signals' classification—the words' left sounds [FR], [DR], [GR], [M], [F], [S], [t∫] define the places of the signals in the column. Signals frizzle, drizzle, grizzle with the FLS=[R] are arranged before the signals with the FLS=[M], and signals with the FLS=[M]—before the signals with the FLS=[F] and so on, according to the order of the Sound Al-phabet, which defines the succession of the final characteristics of signals' classification in the LM.

SUBSECTION 8. The Exhaustive Characteristics of the Signals' Classification in the LM

Let us designate the words stressed syllable by the sign ˜ and the unstressed—by the sign &. Let us call the number of signals' right syllables (signals' right vowels) the structural coefficient of the signal and designate it by the letter K.

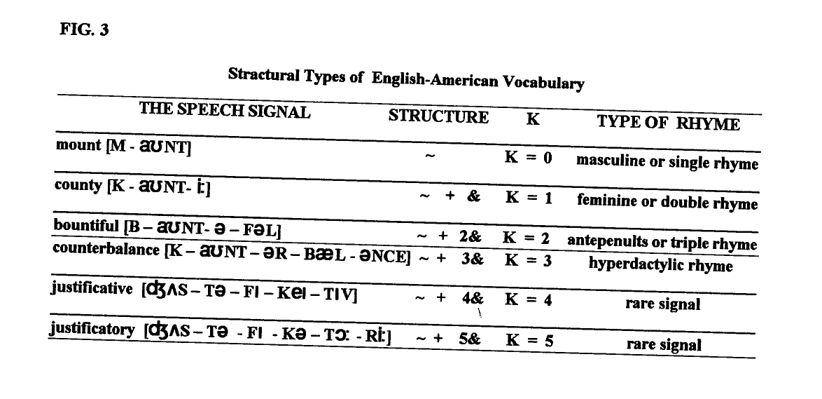

Depending on the structural coefficient, all the signals of the English-American vocabulary may be divided into several structural types (FIG. 3).

Within the limits of one subchannel, the HLC accumulates the sound signals of different structure. The signals of same structure, accumulated in one subchannel produce an absolute rhyming effect or a vowel rhyming effect. For instance:

| | |
|---|---|
| [L - I - Z [symbol] RD] | lizard |
| [M - I - Z [symbol] L] | mizzle |
| [R - I - Z [symbol] N] | risen |
| [D - I - Z [symbol] N] | dizen |

These signals, accumulated by the HLC in the subchannel [lZ [symbol] ] of the channel [lZ], (FIG. 4) belong to the signals of the structural type ˜+&. Some of them rhyme absolutely (risen-disen), and some—approximately (lizard-mizzle).

But how about the signals of different structural types? For instance:

| | |
|---|---|
| [L - I - Z [symbol] RD] | lizard (The stractural type = ˜+ &) |
| [PR - I - Z [symbol] NBReIK [symbol] R] | pris n-breaker (The structural type = ˜ + 3&) |

The signals of different structural type, accumulated in the same subchannel, do not rhyme. If the signals, being accumulated in the same subchannel, don't rhyme, it means that they are accumulated in different flows of the subchannel. Thus, in the LM, the signals, being accumulated in the same subchannel of the HLC, are delimitated, i.e. they possess in the subchannel quite definite space or the accumulation flow, where the signals of this or that structure will be massed. It is hard to say, how the picture of this delimitation looks in the HLC, but this delimitation may be modelled by means of the linguography. In the LM, each subchannel of signals' accumulation is divided into the row of flows (FIG. 4). As a rule, there are five flows, corresponding to the five structural types of signals with the K=0, K=1, K=2, K=3 and K=4. The signals are located in one general column, according to the Sound Alphabet, but the signals of different structure are shifted right into that or that flow, depending on their structure.

The appurtenance of the signals to certain accumulation flow is defined by the number of right vowels (the number of right syllables after the stressed one) i.e. by the structural coefficient of the signal (K).

CONCLUSION. After the exhaustion of the final characteristics of the signals' classification in the LM, which define the location of the signal in the accumulation subchannel, one more characteristic of the classification is established: the number of right vowels. This characteristic is called the exhaustive characteristic of signals' classification in the LM.

The exhaustive characteristic of the signals' classification defines the accumulation flow of signals in the subchannel. Each channel of signals' accumulation in the LM is divided into K^{h}+1 flows, where K^{h} is the highest structural coefficient, found among the signals in subchannels of present channel. As a rule, K^{h}=4, and very seldom K^{h}=5 or K^{h}=6. The Accumulation Channel of the Stressed Syllable [lZ] (FIG. 4) reflects the division of the signals' accumulation channel and subchannels into accumulation flows very visually. The K^{h} of the channel [lZ]=3, because there are no words with the K higher than 3 in the channel [lZ]. So, the channel is divided into K+1 (i.e. 4) flows of accumulation: I+Z=IZ; IZ+&; IZ+2& and IZ+3&.

After selecting the characteristics of the classification in the LM of the SFAS by the HLC, it is easy to compose the diagram of the linguographic method of wordbooking (FIG. 2).

The LM of the SFAS by the HLC is a dictionary, which reflects the genuine picture of the word dictionary that exists in the HLC. The LM is divided into 18 families of sounds, according to the number of stressed vowels in the English-American language. Each family is divided into certain number of channels. There are the following channels in the LM:

The Clan of the Abstract Sound {I}

The channels of the sound [i:]: [i:], [i:R]. [i:L], [i:N], [i:M], [i:V], [i:W], [i:F], [i:B], [i:P], [i:D], [i:T], [i:G], [i:K], [i:H], [i:Z], [i:S], [i: [symbol] ], [i:θ], [i:3], [i:∫], [i:d3], [i:t∫].

The channels of the sound [l [symbol] ]: [l [symbol] ], [l [symbol] R]. [l [symbol] L], [l [symbol] N], [l [symbol] M], [l [symbol] W], [ [symbol] F], [l [symbol] B], [l [symbol] D], [l [symbol] T], [l [symbol] G], [l [symbol] K], [l [symbol] H], [l [symbol] Z], [l [symbol] S], [l [symbol] ∫].

The channels of the sound [l]: [lR]. [lL], [lN], [lη], [lM], [lV], [lF], [lB], [lP], [lD], [lT], [lG], [lK], [lZ], [lS], [l [symbol] ], [lθ], [l3], [l∫], [l3], [lt∫].

The Clan of the Abstract Sound {E}

The channels of the sound [æ]: [æR]. [æL], [æN], [æη], [æM], [æV], [æF], [æB], [æP], [æD], [æT], [æG], [æK], [æZ], [æS], [æ [symbol] ], [æθ], [æ3], [æ∫], [æd3], [æt∫].

The channels of the sound [e [symbol] ]: [e [symbol] R].

The channels of the sound [el]: [el], [leR]. [elL], [elN], [elM], [elV], [elW], [elF], [leB], [elP], [elD], [elT], [elG], [elK], [leH], [elZ], [elS], [el [symbol] ], [elθ], [el3], [el∫], [eld3], [el∫].

The channels of the sound [e]: [eR]. [eL], [eN], [eη] [eM], [eV], [eF], [eB], [eP], [eD], [eT], [eG], [eK], [eZ], [eS], [e [symbol] ], [eθ], [e3], [e∫], [ed3], [et∫].

The Clan of the Abstract Sound {A}

The channels of the sound [α:], [α:R]. [α:L], [α:N], [α:η], [α:M], [α:V], [α:F], [α:B], [α:P], [α:D], [α:T]. [α:G], [α:K], [α:H], [α:Z], [α:S], [α: [symbol] ], [α:θ], [α:3], [α:∫], [α:d3].

The channels of the sound [aυ]: [aυ], [aυR]. [aυL], [aυN], [aυM], [a]W], [aυB], [aυP], [aυD], [aυT], [aυK], [aυH], [aυZ], [aυS], [aυ [symbol] ], [aθ], [a∫], [aυd3], [υt∫].

The channels of the sound [al]: [al], [alR]. [alL], [lN], [alM], [alV], [alW], [alF], [alB], [alP], [alD], [alT], [alG], [alK], [alH], [alZ], [alS], [al [symbol] ], [al∫], [ad3], [alt∫].

The channels of the sound [Λ]: [ΛR]. [ΛL], [ΛN], [Λη] [ΛM], [ΛV], [ΛF], [ΛB], [ΛP], [ΛD], [ΛT], [ΛG], [ΛK], [ΛZ], [ΛS], [Λ [symbol] ], [Λθ], [Λ∫], [Λd3], [Λt∫].

The channels of the sound [ [symbol] ]: [ [symbol] R]. [ [symbol] L], [ [symbol] N], [ [symbol] η] [ [symbol] M], [ [symbol] V], [ [symbol] F], [ [symbol] B], [ [symbol] P], [ [symbol] D], [ [symbol] T], [ [symbol] G], [ [symbol] K], [ [symbol] H], [ [symbol] Z], [ [symbol] S], [ [symbol] [symbol] ], [ [symbol] θ], [ [symbol] ∫], [ [symbol] d3],[ [symbol] t∫].

The Clan of the Abstract Sound {O}

The channels of the sound [ [symbol] ]: [ [symbol] R], [ [symbol] :V]. The channels of the sound [ [symbol] ]: [ [symbol] :], [ [symbol] :R]. [ [symbol] :L], [ [symbol] :J] [ [symbol] :N], [ [symbol] :η], [ [symbol] :M], [ [symbol] :F], [ [symbol] :B], [ [symbol] :P], [ [symbol] :D], [ [symbol] :T], [ [symbol] :T], [ [symbol] :K], [ [symbol] :H], [ [symbol] :Z], [ [symbol] :S], [ [symbol] :θ], [ [symbol] :∫].

The channels of the sound [ [symbol] υ]: [ [symbol] υ], [ [symbol] υR]. [ [symbol] υL], [ [symbol] υN], [ [symbol] υM], [ [symbol] υV], [ [symbol] υW], [ [symbol] υF], [ [symbol] υB], [ [symbol] υP], [ [symbol] υD], [ [symbol] υT], [symbol] υG], [ [symbol] υK], [ [symbol] υH], [ [symbol] υZ], [ [symbol] υS], [ [symbol] υ [symbol] ], [ [symbol] υθ], [ [symbol] υ3], [ [symbol] υ∫], [ [symbol] υd3], [ [symbol] υt∫].

The channels of the sound [O/ [symbol] l]: [O], [OR]. [OL], [ [symbol] l], [ [symbol] lR]. [ [symbol] lL], [ [symbol] N], [ [symbol] lM], [ [symbol] lF], [ [symbol] lB], [ [symbol] lD], [ [symbol] lT], [ [symbol] lK], [ [symbol] lH], [ [symbol] lZ], [ [symbol] lS], [ [symbol] l∫], [ON], [Oη], [OM], [OV], [OF], [OG], [OS], [Oθ], [O∫].

The Clan of the Abstract Sound {U}

The channels of the sound [U:]: [U:], [U:L], [U:N], [U:M], [U:V], [U:F], [U:B], [U:P], [U:D], [U:T], [U:G], [U:K], [U:Z], [U:S], [U: [symbol] ], [U:θ], [U:3], [U:∫], [U:d3], [U:t∫].

The channels of the sound [υ]: [υ], [υR]. [υL], [υM], [υD], [υT], [υG], [υK], [υZ], [υS], [υ [symbol] ], [υ∫], [υt∫].

It is obvious from this list that the linguographic dictionary that simulates the natural dictionary, existing in the HLC, is composed from a certain numbers of channels. The channel is the composing unit of the linguographic model. So, in order to imagine the structure of the LM, it is quite enough to look through a separate channel of the LM. Such a separate channel—the Channel of the Stressed Stllable [lZ] is presented on the FIG. 4. The next section is dedicated to this channel.

SUBSECTION 9. The Accumulation Channel of the Stressed Syllable [lZ]

The Accumulation Channel of the Stressed Syllable [lZ] (FIG. 4) is an excerpt from the LM of the SFAS in the HLC, created by the inventor on the basis of English vocabulary, listed in the English-Russian dictionary, containing 35,000 English words. The Channel of the Stressed Syllable [lZ] gives an idea of the LM, displaying a part of the LM: the channel [lZ] from the family of the sound [l]. The full LM of the SFAS by the HLC is compiled of 330 such channels, representing the vocabulary of 35,000 English words.

Each word in the LM is supplied with a symbol in italics (to the right of each signal), which encodes the grammatical information of the signal⁴. For instance:
⁴ Some signals in the FIG. 4 are not supplied with the encoded information. It is done in order not to overload the text with the unnecessary signs. The information of the previous word should be applied to the words without the codes.

| | |
|---|---|
| busy | a\v\n |

The letters a/v/n are codes of the words adjective, verb and noun. The Decoding Chapter, located in the end of the LM, decodes the information, encoded in the letters n, v, a etc. The short excerpt from the Decoding Chapter is presented in the section 11.

SUBSECTION 10. Remarks to the Use of the Sound Alphabet

A. The classification characteristics are defined for the LM on the basis of the phonetic transcription, known as the International Phonetic Alphabet. So, the succession of the classification characteristics are defined, according to the Sound Alphabet, in confirmity with the phonetic transcription of signals. The future compiler of the linguographically composed lexicons for the electronic devices may write the signals on the defined locations by the today's spelling or by the phonetic transcription. This choice will depend on the specific object of the lexicon for this or that user-compiler. For instance, the signals in the The Accumulation Channel of the Stressed Syllable [lZ] (FIG. 4) are listed in two ways:

| | |
|---|---|
| [L - IZ [symbol] - RD] | lizard |
| [BL - IZ [symbol] - RD] | blizzard |
| [W - IZ [symbol] - RD] | wizard |
| [G - IZ [symbol] - RD] | gizzard |
| [S - IZ [symbol] - RZ] | scissors |

But the succession of the signals in the second column (traditional spelling) should be based on the first column (phonetic transcription), because the phonetic transcription reflects the genuine sound structure of the signals.

B. The locations of the signals with the doubled consonants are defined accord ing to the phonetic transcription, that disregards the reduplication in most cases. The word mizzen in the subchannel [lZ [symbol] ] is the example of the aforesaid (FIG. 4). This word is located in the row of similar ending words as if it has no doubled Z, because it is pronounced [MlZ [symbol] N].

SUBSECTION 11. The Excerpt from the Decoding Chapter

The grammatical information about the speech signals is presented in the Decoding Chapter, where the grammatical symbols of words are decoded. A short excerpt from the Decoding Chapter will give the idea of its composition:
n, n⁰, n¹, n², n₁, n₂,—signals represent Singular of Nomina

-n—the signal in the Plural form:

| | |
|---|---|
| 1. after vowels and [R, L, J, N, M, V, B, D, G] | −n = n + [Z]; |
| | dog → dogs [DOGZ] |
| 2. after [F, P, T, K] | −n = n + [S] |
| | cup → cups [CUPS] |
| 3. after [Z, S, Õ, θ, 3, ∫, d_{B}, t∫] | −n = n + [IZ] |
| | witch → witches [Wrt∫IZ] |

n⁰ - - - the signal does not create Plural:

for instance: providence

n¹ - - - signals' Singular and Plural coinside:

n¹ = −n¹
sheep = sheep

n² - - - compound noun: only the fisrt part of the signal creates Plural:

| | |
|---|---|
| n² = n + pr⁵ + n; | −n² = −n + pr + n |
| n² = comrade-in-arms; | −n² = comrades-in-arms |
| | [KOMR∂DZ-IN-ARMZ] |

. . . and . . . so . . . on . . . for the symbols
n, v, a, pn, pr etc . . .
⁵pr - the code for preposition

This short excerpt from the Decoding Chapter of the LM gives an idea, how this chapter is compiled. It is obvious, however, that the use of the linguographic method for the compiling word dictionaries and lexicons for different electronic speech-recognition devices (SRD) (speech-to-text devices, speech-to-speech devices, language-to-language devices etc.) will require different composition of the Decoding Chapter.

It is possible, that in some lexicons, not only the words' primary forms, but all words' derivative forms will be listed also. In such a case, there will be no need in the Decoding Chapter, because the recognition of the derivatives will occur in the lexicon.

Using the Linguographic Method for the Compiling the Word Dictionaries and Lexicons, Assigned to the SRD

The described Linguographic Model of the System of the Formal Accumulation (and Storage) of the Speech Signals by the Human Language Center is a model that represents by linguistic means a list of speech signals, preserved in the human memory according to signals' sound nature. In other words, the LM of the SFAS by the HLC is the copy of the natural dictionary that exists in human memory. This natural dictionary is not written on paper, but it exists in human brain as a result of accumulation of sound speech signals, and the Linguographic Method allows modelling it on the paper.

The speech-recognition devices that decode the spoken language, in order to be as efficient as human brain and even more, have to use in theirs equipments the word dictionaries and lexicons that most accurately copy the natural dictionary that exists in human brain.

The described Linguographic Method is the most efficient and most perspective method for compiling the words dictionaries and lexicons for the speech-recognition devices.

### DESCRIPTION OF THE PREFERRED EMBODIMENT

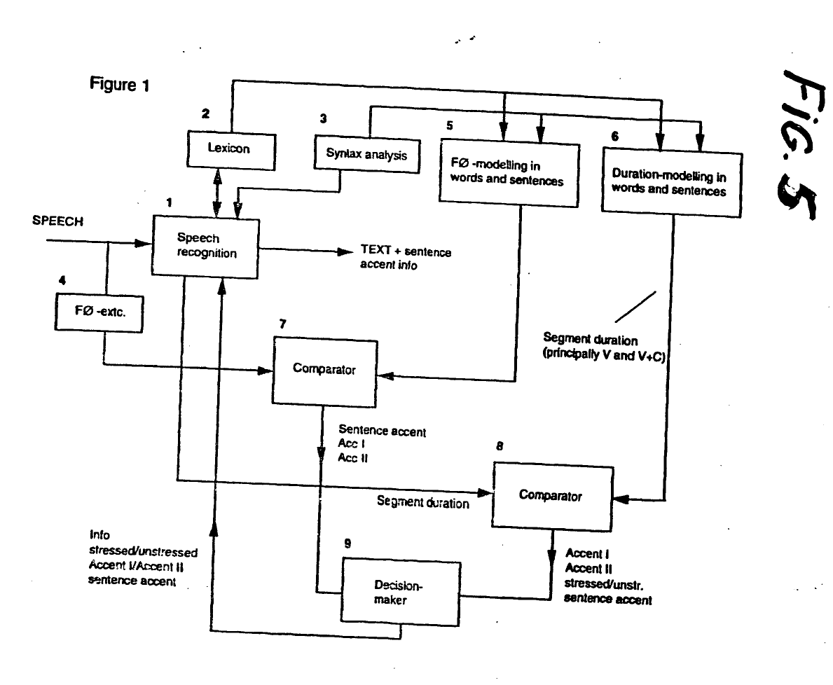

The compiling the word dictionaries or lexicons for inputting into memories of speech-recognition devices, according to the described above Linguographic Method, will simplify the process of speech-recognition. How this process will be simplified exactly, it may be shown on the U.S. Pat. No. 5,806,033, diagrammatically depicted on the FIG. 5.

Here is the citation from the said Patent: “By the analysis in the speech recognition equipment (1) are obtained a number of recognized sounds which are put together in words and sentences. One consequently obtains a set of combinations of syllables which are possible to combine in different words. Said words consist of words which exist in the language, respective words which do not exist in the language. In a first check of the recognized words, possible combination are transferred to the lexicon, 2. . . . In the lexicon different possible words are checked, which can be created from the recognized speech segment. From the lexicon information, information about the possible words which can exist based on the recognized speech is fed back.”

Let us notice the words possible and can.

As we see from this description, the lexicon, used in the device, did not recognize the separate words from the flow of speech. It happens because the traditionally compiled lexicon does not reflect the real picture of the accumulation and storage of the speech signals in the HLC. Therefore the real sonic data—tones and accent,—received by the speech recognition unit, can not be recognized at once in the lexicon. The information, obtained in lexicon, requires a row of analyses in units 5, 6, 7, 8, 9. But if the lexicon, used in the said device, would be compiled by the Linguographic Method, the recognition of the words will start at once in the lexicon. The stressed vowels of the recognizable words would be considered in the lexicon, as the main element by which the recognition of speech signals will start. So, in the linguographic composed lexicon, the recognition of the speech signals will start at once in the lexicon and will require far less analysis than are depicted in the block diagram of the said device (FIG. 5), which uses the existing traditional lexicons for the speech recognition. In case of use by the inventor of the said Patent the linguographically composed lexicon, the speech segments (the right and left parts of the signals) from the unit 1 would be attributed to the appropriate stressed vowels already in lexicon, and it might be said that “from the lexicon information, information about certain (not possible) words which exist (not can exist), based on the recognized speech is fed back.” Such information will simplify all the further process of speech recognition.

It is quite clear, however, that the Linguographic Method can not exclude some necessary analysis—for instsnce, synthax analysis, omonims analysis, analysis of the unstressed words (prepositions and conjunctions). But the number of analysis and comparisons will be reduced.

In today's electronic devices the natural tonal system of recognizing words, used in the HLC is ignored. “In this type of analysis the fundamental tone and the duration information are regarded as disturbances”—writes the inventor of the U.S. Pat. No. 5,806,033. But for the HLC these disturbances are exactly the means by which it achieves its phenomenal ability to accumulate, recognize and translate the human speech. The inventor of the cited Patent made a revolutionary step in order to use this “disturbant” information for the speech recognition. But the lexicon, composed by the traditional lexicographic method, forced him to do a row of analysis in order to reconciliate and coordinate his new “disturbances-oriented” method with the traditionally composed lexicon. The next step in order to improve the function of speech-recognition devices should be to replace the traditionally composed lexicons with some, based on the “disturbances-oriented” linguographic method.

The embodiment of the natural method of words' accumulation by the HLC into the electronic speech-recognition devices will simplify and improve the function of existing devices. The embodiment of the linguographic method for the word dictionaries and lexicons of said devices will require the rearrangement of all word dictionaries, used in devices' memories and speech-recognition equipments, according to the rules of the linguographic method.

1. The Linguographic Method of compiling word dictionaries and lexicons for the memories and other equipments of speech-recognition devices.

2. The Sound Alphabeth, used in the claim 1 for defining the sucsession of the characteristics of signals' classification in word dictionaries and lexicons, compiled by the Linguographic Method.

3. The newly introduced characteristics of signals' classification, used in claim 1 for compiling word dictionaries and lexicons by the Linguographic Method:
the primary characteristic,
the second characteristic,
the subsequent characteristics,
the final characteristics,
the exhaustive characteristic.
